(19) United States
(12) Patent Application Publication
(10) Pub. No.: US 2014/0333156 A1
(43) Pub. Date: Nov. 13, 2014

(54) ELECTRIC POWER GENERATION DEVICE

(71) Applicant: FUJITSU LIMITED, Kawasaki-shi (JP)

(72) Inventors: Osamu Toyoda, Akashi (JP); Takeaki Shimanouchi, Akashi (JP)

(73) Assignee: FUJITSU LIMITED, Kawasaki (JP)

(21) Appl. No.: 14/337,629

(22) Filed: Jul. 22, 2014

Related U.S. Application Data
(63) Continuation of application No. PCT/JP2012/001761, filed on Mar. 14, 2012.

(51) Int. Cl. H02N 2/18

(52) U.S. Cl. CPC H02N 2/186
USPC 310/26

(57) ABSTRACT

An electric power generation device comprising: a support member; a first magnetostrictive member with one end attached to the support member; a second magnetostrictive member with one end attached to the support member and disposed in parallel with the first magnetostrictive member; a vibration linking member connecting the first and second magnetostrictive members to allow the first and second magnetostrictive members to vibrate coordinately; a coil wound around at least either the first magnetostrictive member or the second magnetostrictive member; and a magnetic path forming member containing magnet, connecting magnetically between one ends of the first and second magnetostrictive members and between the other ends thereof, applying magnetic fields of opposite directions mutually to the first and second magnetostrictive members, respectively, and forming magnetic path, the first and second magnetostrictive members acting mutually as magnetic return parts of the magnetic path.

### CROSS REFERENCE TO RELATED APPLICATION

This application is a continuation application of an International Patent application PCT/JP2012/001761, filed in Japan on Mar. 14, 2012, the whole contents of which are incorporated herein by reference.

### BACKGROUND

1. Field

The embodiments discussed herein are related to an electric power generation device.

2. Related Art

Magnetostriction is defined as deformation of a magnetic substance caused by an applied external magnetic field. The magnetized state in a magnetostrictive material, i.e., a material that can undergo magnetostriction, changes when the magnetostrictive material in an applied external magnetic field is deformed by applying an external force. This phenomenon is referred to as inverse magnetostriction or Villari effect. Power generation devices that utilize inverse magnetostriction have been proposed (e.g., Patent Document 1, and Non-Patent Documents 1 and 2).

[Patent Document 1] Japanese Laid-open Patent Publication No. 09-090065

[Non-Patent Document 1] An Introduction to Inverse Magnetostrictive Vibration Power Generator Developed By SMT, Shonan-metaltec Corporation, internet <URL: http://www.shonan-metaltec.com/HPdata/info_gyakujiwai_hatudenki.pdf> (accessed Feb. 7, 2012)

[Non-Patent Document 2] Micro Vibration Power Generation Element Formed of Magnetostrictive Material, Toshiyuk Ueno, Internet <URL: http://jstshingi.jp/abst/p/10/1022/kanazawa1.pdf> (accessed Feb. 7, 2012)

### SUMMARY

An object of the present invention is to provide an electric power generation device utilizing inverse magnetostriction and having a novel structure.

According to an aspect of the present invention, there is provided an electric power generation device comprising:

a support member;

a first magnetostrictive member attached to the support member, one end of the first magnetostrictive member acting as a fixed end to the support member, and the other end of the first magnetostrictive member acting as a vibratable end;

a second magnetostrictive member attached to the support member and disposed in parallel with the first magnetostrictive member, one end of the second magnetostrictive member acting as a fixed end to the support member, and the other end of the second magnetostrictive member acting as a vibratable end;

a vibration linking member connecting the first and second magnetostrictive members to allow the first and second magnetostrictive members to vibrate coordinately;

a coil wound around at least either the first magnetostrictive member or the second magnetostrictive member; and

a magnetic path forming member containing magnet, connecting magnetically between one ends of the first and second magnetostrictive members and between the other ends thereof, applying magnetic fields of opposite directions mutually to the first and second magnetostrictive members, respectively, and forming magnetic path, the first and second magnetostrictive members acting mutually as magnetic return parts of the magnetic path.

A magnetic path, that an ends of a first magnetostrictive member and a second magnetostrictive member are magnetically connected and the other ends thereof are magnetically connected, that magnetic fields of opposite directions are applied to the magnetostrictive members, and that the magnetostrictive members act mutually as magnetic return parts of the magnetic path, can be formed. For example, this makes it easier to decrease the rigidity of the vibratable portion of a vibration power generation device and thereby improve its power generation efficiency.

The object and advantages of the invention will be realized and attained by means of the elements and combinations particularly pointed out in the claims.

It is to be understood that both the foregoing general description and the following detailed description are exemplary and are not restrictive of the invention, as claimed.

### BRIEF DESCRIPTION OF THE DRAWINGS

FIG. 1 is a schematic front view of a vibration power generation device (in the standard state) according to a first embodiment.

FIG. 2 is a schematic front view of a vibration power generation device (in a strained state) according to the first embodiment.

FIG. 3A to FIG. 3C are schematic front views of vibration power generation devices according to the first to third modifications, respectively, of the first embodiment.

FIG. 4 is a schematic front view of a vibration power generation device (in a strained state) according to the fourth modification of the first embodiment.

FIG. 5 is a schematic front view of a vibration power generation device according to the second embodiment.

FIG. 6A and FIG. 6B are schematic front views of vibration power generation devices according to the third embodiment and a modification of the third embodiment, respectively.

FIG. 7A and FIG. 7B are a schematic top view and a schematic front view, respectively, of a vibration power generation device according to a comparative example.

### DESCRIPTION OF THE PREFERRED EMBODIMENTS

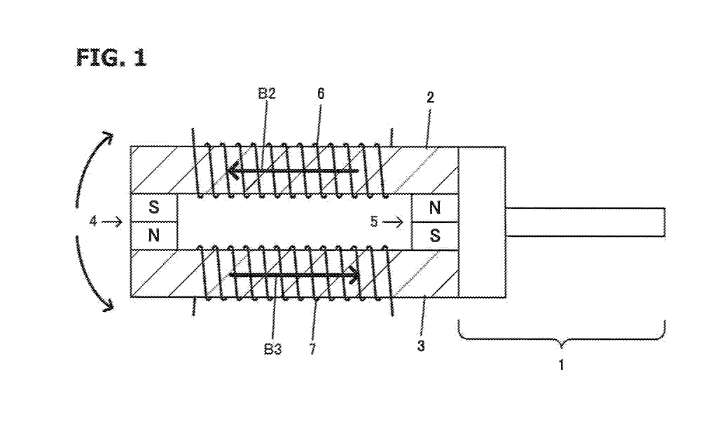

First, the structure of the vibration power generation device according to the first embodiment of the present invention is described below with reference to FIG. 1. Various processing techniques may be applied appropriately to production of a power generation device. FIG. 1 is a schematic front view of a vibration power generation device according to the first embodiment. Magnetostrictive members 2 and 3, made of magnetostrictive materials, are attached to a support member 1.

Magnetostrictive materials that can be used to form the magnetostrictive members 2 and 3 include, for example, positive magnetostrictive materials (such as iron-gallium alloys (Galfenols). The magnetostrictive members 2 and 3 may have, for example, an identical shape, which may be in the form of a plate extended in one direction (with, for example, a thickness of 2 mm, width of 4.6 mm, and length of 60 mm). The magnetostrictive members 2 and 3 are disposed to face with each other, and each member has a cantilever structure that one end (a fixed end) along the length-direction is fixed to the support member 1 and the other end (a vibratable end) is vibratable in the thickness direction. The support member 1 is made of, for example, a nonmagnetic substance such as copper. For power generation, the support member 1 is equipped with an external vibration source such as machine, and the magnetostrictive members 2 and 3 vibrate.

A permanent magnet 4 connects the vibratable ends of the magnetostrictive members 2 and 3 (the vibratable ends of the magnetostrictive members 2 and 3 are bonded to each other via the permanent magnet 4). A permanent magnet 5 connects the fixed ends of the magnetostrictive members 2 and 3. The permanent magnets 4 and 5 may each be, for example, a neodymium magnet with a strength of 0.5 T. The connection of the vibratable ends via the permanent magnet 4 allows the magnetostrictive members 2 and 3 to vibrate in a linking and united manner. From the viewpoint of linking vibration, the member that connects the magnetostrictive members 2 and 3 at the vibratable ends is not necessarily a magnet.

The permanent magnets 4 and 5 are magnetized in the thickness direction of the magnetostrictive members and in the opposite directions to each other. As seen in FIG. 1, for example, the permanent magnet 4 has an S pole and an N pole at the upper and lower ends, respectively, in the diagram, and the permanent magnet 5 has an N pole and an S pole at the upper and lower ends, respectively, in the diagram. The magnetic path formed in the embodiment given in FIG. 1 runs from the S pole to the N pole of the permanent magnet 4, from the vibratable end to the fixed end of the magnetostrictive member 3, from the S pole to the N pole of the permanent magnet 5, and from the fixed end to the vibratable end of the magnetostrictive member 2, and returns to the permanent magnet 4.

Namely, the magnetic field applied to the magnetostrictive member 2 by the permanent magnets 4 and 5 is in the direction from the fixed end towards the vibratable end, and the magnetic field applied to the magnetostrictive member 3 is in the direction from the vibratable end towards the fixed end. Thus, the magnetic field applied to the magnetostrictive member 2 and that applied to the magnetostrictive member 3 are in the opposite directions. It can be assumed that the magnetostrictive member 2 and the magnetostrictive member 3 are acting as yokes that serve as mutually magnetic return parts of magnetic path.

As a magnetic field is applied by the permanent magnets 4 and 5, a magnetic flux with a density B2 occurs from the fixed end towards the vibratable end in the magnetostrictive member 2, and a magnetic flux with a density B3 occurs from the vibratable end towards the fixed end in the magnetostrictive member 3. A coil 6 is wound around the magnetostrictive member 2, and a coil 7 is wound around the magnetostrictive member 3. In the embodiment given in FIG. 1, the coils 6 and 7 are wound in the same direction with respect to the bias magnetic field.

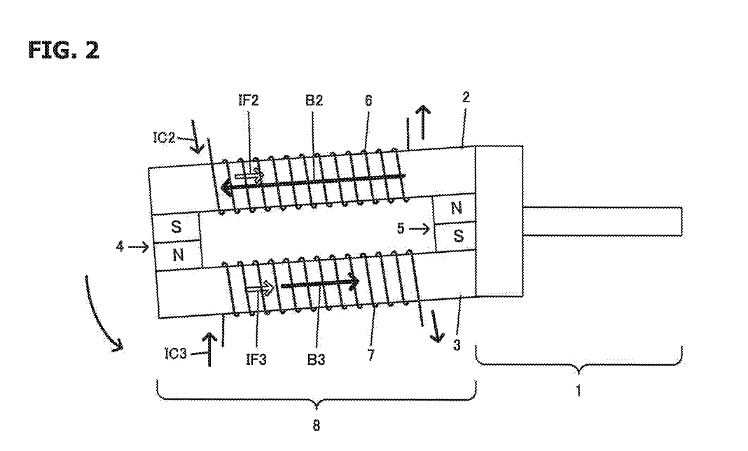

The mechanism of the vibration power generation device according to the first embodiment is described below with reference to FIG. 2. FIG. 2 illustrates the magnetostrictive members 2 and 3 that are in a strained state during vibration, where the magnetostrictive members 2 and 3 are strained in the downward direction in the diagram.

Compared to this, FIG. 1 illustrates the magnetostrictive members 2 and 3 that are not vibrating or in an unstrained state during vibration. The non-vibrating or unstrained state illustrated in FIG. 1 is hereinafter referred to as standard state while a state that is strained as illustrated in FIG. 2 is hereinafter referred to as strained state.

As the vibratable ends of the magnetostrictive members 2 and 3 are connected via a vibration linking member (permanent magnet) 4, the magnetostrictive members 2 and 3 vibrate coordinately. The structure 8, which combines the magnetostrictive members 2 and 3, is designed so that the neutral plane with respect to the strain caused by vibration in the vertical direction is located between the magnetostrictive members 2 and 3.

Accordingly, a downward strain of the structure 8 in the diagram causes a tensile strain in the upper magnetostrictive member 2 and a compressive strain in the lower magnetostrictive member 3. On the other hand, an upward strain of the structure 8 in the diagram causes a compressive strain in the upper magnetostrictive member 2 and a tensile strain in the lower magnetostrictive member 3. As they vibrate, the magnetostrictive members 2 and 3 repeatedly undergo a cycle consisting of a strain-free standard state, a strained state with a compressive strain, a strain-free standard state, and a strained state with a tensile strain. The strain in the magnetostrictive member 2 and that in the magnetostrictive member 3 are in the opposite directions (i.e., either a compressive strain or a tensile strain).

In general, the magnetic flux density in a magnetostrictive material changes as the magnetostrictive material is deformed in a state that an external magnetic field is applied (inverse magnetostriction or Villari effect). A positive magnetostrictive material such as, for example, Galfenol is used as the magnetostrictive material, and the intensity of the applied magnetic field is controlled so that the magnetic flux density in the magnetostrictive members in the standard state will not be saturated (approximately 50% or less of saturation magnetization).

When a magnetostrictive member undergoes a tensile strain, or extends, the lengthwise component (magnetization component) of the magnetic flux density that occurs in the magnetostrictive member becomes larger than that in the standard state. When a magnetostrictive member undergoes a compressive strain, or shrinks, the lengthwise component (magnetization component) of the magnetic flux density that occurs in the magnetostrictive member becomes smaller than that in the standard state. Accordingly, the lengthwise component of the magnetic flux density that occurs in each magnetostrictive member fluctuates periodically as it vibrates.

An induced electric current occurs in the coils 6 and 7 in such a manner as to resist the change in magnetic flux density caused by vibration of the magnetostrictive members 2 and 3, respectively. This serves to generate electric power. In the state illustrated in FIG. 2, for example, an induced electric current IC2 flows in the coil 6 wound around the upper magnetostrictive member 2 from the vibratable end towards the fixed end of the magnetostrictive member 2 so that an induced magnetic field IF2 is generated in such a direction as to resist an increase in the magnetic flux density B2 (an inducted electric current IC2 flows in the coil to cause a magnetic field IF2 that resists changes in the magnetic flux). This works as an electric power source with the fixed end and the vibratable end having positive polarity and negative polarity, respectively.

On the other hand, an induced electric current IC3 flows in the coil 7 wound around the upper magnetostrictive member 3 from the vibratable end towards the fixed end of the magnetostrictive member 3 so that an induced magnetic field IF3 is generated in such a direction as to resist an increase in the magnetic flux density B3 (an inducted electric current IC3 flows in the coil to cause a magnetic field IF3 that resists changes in the magnetic flux). This works as an electric power source with the fixed end and the vibratable end having positive polarity and negative polarity, respectively.

In the embodiment given in FIG. 2, the coil 6 and the coil 7 are wound up in the same direction relative to the bias magnetic field so that the vibratable ends and the fixed ends of the magnetostrictive member 2 and the magnetostrictive member 3 can have the same power source polarities. It should be noted that if the coil 6 and the coil 7 are wound up in the opposite directions to each other, the magnetostrictive member 2 and the magnetostrictive member 3 have the opposite power source polarities, but power generation can be implemented by the same mechanism as above.

Here, the shape of the magnetostrictive members 2 and 3 is not limited to plate-like, and they may have, for example, a rod-like shape. From the viewpoint of causing efficient vibration, however, it is preferable to adopt a shape having such anisotropy as to easily cause vibration in a particular direction as in the above embodiment. The magnetostrictive members 2 and 3 are preferably arranged in the same direction and the direction is preferably such that vibration can be caused easily.

In the above embodiment, the vibratable end and the fixed end of the magnetostrictive member 2 and those of the magnetostrictive member 3 are connected directly to each other via the magnets 4 and 5 to form a magnetic path. Forming a magnetic path through a magnetic connection between the vibratable ends and between the fixed ends of the magnetostrictive members 2 and 3 is not limited to the structure according to the above embodiment. Other magnetic path formation structures include, for example, the first to third modifications given below.

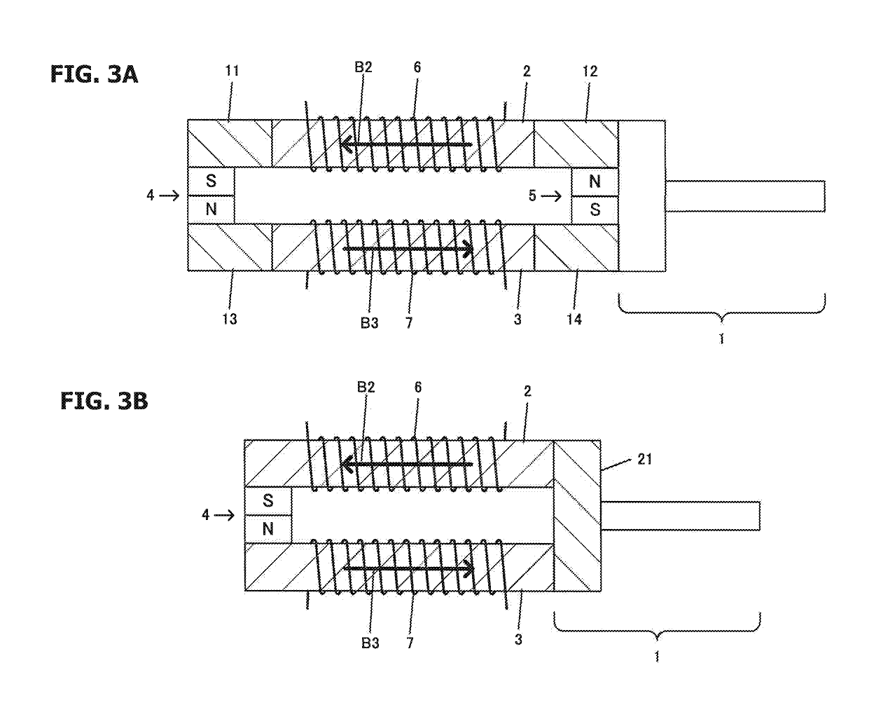

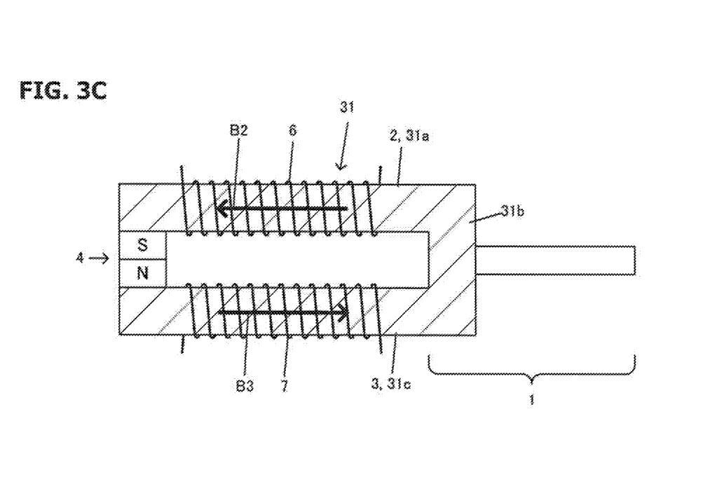

First, a vibration power generation device according to the first modification of the first embodiment is described below with reference to FIG. 3A. In the first modification, yoke members 11 and 12 are connected to the outermost face of the vibratable end and the outermost face of the fixed end, respectively, of the magnetostrictive member 2, while yoke members 13 and 14 are connected to the outermost face of the vibratable end and the outermost face of the fixed end, respectively, of the magnetostrictive member 3. The yoke members 11 to 14 may be made of, for example, soft iron. Here, for easy understanding of the diagrams, the magnetostrictive members are illustrated with right-up diagonal lines while the yoke members are illustrated with left-up diagonal lines.

The fixed ends of the magnetostrictive members 2 and 3 are attached to the support member 1 via the yoke members 12 and 14, respectively. At the vibratable ends, the yoke member 11 and the yoke member 13 are connected to each other via a permanent magnet 4 while at the fixed ends, the yoke member 12 and the yoke member 14 are connected to each other via a permanent magnet 5. Thus, this structure presents another example of magnetic path formation.

It should be noted that in the first modification, the yoke member 11, permanent magnet 4, and yoke member 13 work not only as a magnetic connection member that magnetically connects the magnetostrictive member 2 and the magnetostrictive member 3, but also as a mechanical connection member (vibration linking member) that links the vibration of the magnetostrictive member 2 and the vibration of the magnetostrictive member 3.

Next, a vibration power generation device according to the second modification of the first embodiment is described below with reference to FIG. 3B. The permanent magnet 4 in this structure works to connect the magnetostrictive members 2 and 3 at their vibratable ends, as in the case of the first embodiment. In the second modification, the fixed ends of the magnetostrictive members 2 and 3 are attached to a yoke member 21 so that the magnetostrictive members 2 and 3 are magnetically connected by the yoke member 21 at their fixed ends. This structure presents another example of magnetic path formation. Here, it can also be regarded that the yoke member 21 is acting as part of a support member 1 that forms a cantilever structure to support the magnetostrictive members 2 and 3.

Next, a vibration power generation device according to the third modification of the first embodiment is described below with reference to FIG. 3C. In this structure, the permanent magnet 4 works to connect the magnetostrictive members 2 and 3 at their vibratable ends, as in the case of the first embodiment. The third modification uses a magnetostrictive member 31 that has a U-shaped thicknesswise cross section and consists of two opposite portions 31a and 31c and a connection portion 31b that connects them together.

The opposite portions 31a and 31c of the magnetostrictive member 31 play the role of the magnetostrictive members 2 and 3, respectively. The connection portion 31b of the magnetostrictive member 31 functions as a yoke that magnetically connects the magnetostrictive members 2 and 3 at the fixed ends. Here, it can also be regarded that the connection portion 31b is acting as part of a support member 1 that forms a cantilever structure to support the magnetostrictive members 2 and 3. As in the third modification, the magnetostrictive members 2 and 3 may not be separated from each other. This structure presents another example of magnetic path formation.

It should be noted that in the first embodiment and the first to third modifications, a permanent magnet is disposed in the connection member that magnetically connects the vibratable ends of the magnetostrictive members 2 and 3, but only a yoke member may be used as the connection member that magnetically connects the vibratable ends of the magnetostrictive members 2 and 3 (see, for example, the third embodiment described later). The magnetic path only requires one permanent magnet located somewhere in the magnetic path.

In the first embodiment and the first to third modifications, both the magnetostrictive members 2 and 3 are made of a positive magnetostrictive material, but the magnetostrictive members 2 and 3 may not necessarily be of a positive magnetostrictive material.

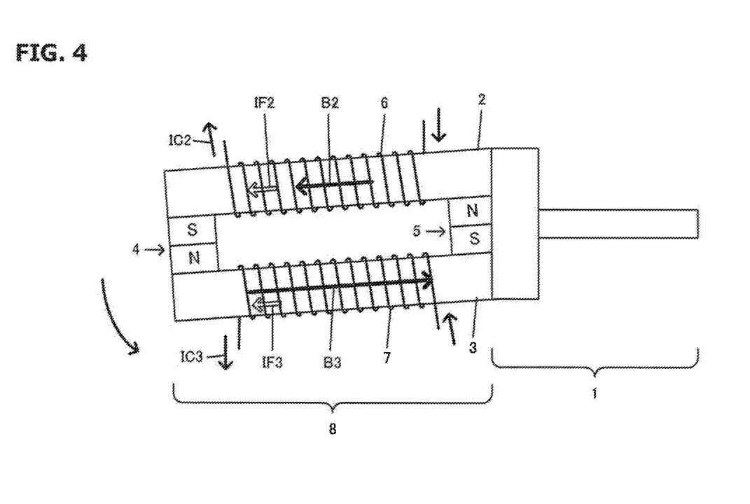

Next, a vibration power generation device according to the fourth modification of the first embodiment is described below with reference to FIG. 4. The fourth modification presents an example in which both the magnetostrictive members 2 and 3 are made of a negative magnetostrictive material. The magnetostrictive members 2 and 3 illustrated in FIG. 4 are strained downward in the diagram as in FIG. 2.

In a negative magnetostrictive material, the density of magnetic flux caused in a magnetostrictive member in an applied magnetic field is decreased by a tensile strain and increased by a compressive strain, contrary to the case of a positive magnetostrictive material. In the state illustrated in FIG. 4, therefore, an induced electric current IC2 flows in the coil 6 wound around the upper magnetostrictive member 2 so that an induced magnetic field IF2 is generated in such a direction as to resist a decrease in the magnetic flux density B2 while an induced electric current IC3 flows in the coil 7 wound around the lower magnetostrictive member 3 so that an induced magnetic field IF3 is generated in such a direction as to resist an increase in the magnetic flux density B3. Thus, electric power can be generated if both the magnetostrictive members 2 and 3 are of a negative magnetostrictive material.

It should be noted that power can be generated separately in the magnetostrictive member 2 and in the magnetostrictive member 3. And accordingly, as another modification, the magnetostrictive members 2 and 3 may be made of magnetostrictive materials of different types, i.e., positive or negative. Since power can be generated separately in the magnetostrictive member 2 and in the magnetostrictive member 3, electric power can be generated if either of the magnetostrictive members has a coil wound up on it.

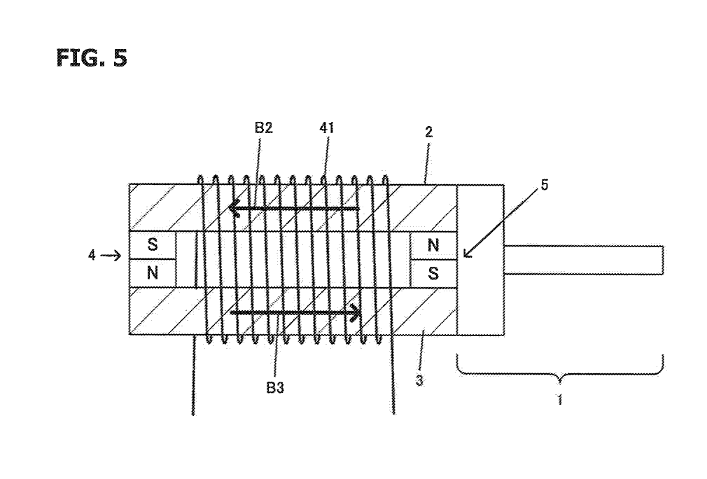

Next, a power generation device according to the second embodiment is described below with reference to FIG. 5. FIG. 5 is a schematic front view of a vibration power generation device according to the second embodiment. A shared coil 41 is wound on the magnetostrictive members 2 and 3 in the second embodiment, instead of winding separate coils 6 and 7 on the magnetostrictive members 2 and 3 as in the first embodiment. Otherwise, the structure is the same as that according to the first embodiment given in FIG. 1. The magnetostrictive members 2 and 3 are made of the same type (positive or negative), and for example, both of them are made of a positive magnetostrictive material. In the second embodiment (and in the third embodiment and its modification described later), the illustration of coils is partly simplified to avoid complication.

Here, refer to FIG. 2 and FIG. 4, again. Induced magnetic fields IF2 and IF3 are generated in the same direction through the coils 6 and 7 wound on the magnetostrictive members 2 and 3 when both the magnetostrictive members 2 and 3 are made of a positive magnetostrictive material as illustrated in FIG. 2, or when both the magnetostrictive members 2 and 3 are made of a negative magnetostrictive material as illustrated in FIG. 4, that is, when the magnetostrictive materials that constitute the magnetostrictive members 2 and 3 are of the same magnetostriction type (positive or negative).

Accordingly, if the magnetostrictive materials that constitute the magnetostrictive members 2 and 3 are of the same magnetostriction type (positive or negative), power can be generated by using a shared coil 41 wound around the magnetostrictive members 2 and 3. Thus, for example, the trouble of winding separate coils around the magnetostrictive members 2 and 3 can be saved.

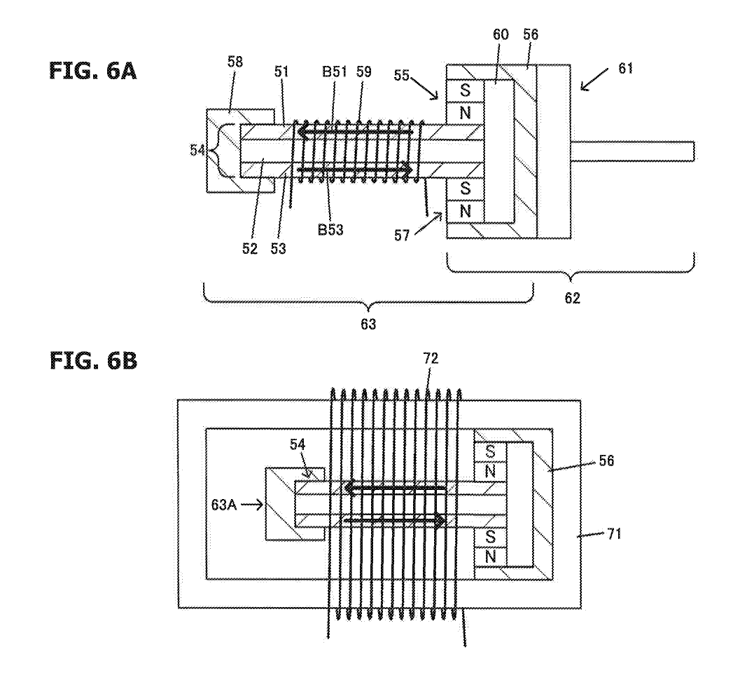

Next, a power generation device according to the third embodiment is described below with reference to FIG. 6A. FIG. 6A is a schematic front view of a vibration power generation device according to the third embodiment. Thin film-like magnetostrictive members (magnetostrictive layers) 51 and 53 are disposed on the top face and the bottom face of a support layer 52 to form a structure 54. As in the second embodiment, the magnetostrictive materials forming the magnetostrictive layers 51 and 53 are of the same magnetostriction type (positive and negative).

The magnetostrictive layers 51 and 53 are made of, for example, Galfenol ribbon material (for example, with a thickness of 300 μm) produced by the rapid liquid solidification method. The support layer 52 is, for example, a plastic plate (for example, with a thickness of about 500 μm). The magnetostrictive layers 51 and 53 can be attached on the support layer 52 by, for example, bonding with an adhesive. If magnetostrictive members with adequate toughness are not available, appropriate magnetostrictive members may be formed on a support layer as described above. Here, the thin film-like magnetostrictive members may be in the form of thin plates produced by cutting and polishing or films produced by thin film sputtering.

The fixed end of the structure 54 is sandwiched between an upper permanent magnet 55 and a lower permanent magnet 57, and the permanent magnet 55 and the permanent magnet 57 are connected via a yoke member 56. Thus, the fixed ends of the magnetostrictive layers 51 and 53 are magnetically connected to each other via the permanent magnet 55, yoke member 56, and permanent magnet 57. On the other hand, the vibratable ends of the magnetostrictive layers 51 and 53 are magnetically connected to each other via the yoke member 58 that hold the structure 54 from above and below. A magnetic path is thus formed in the third embodiment.

In the third embodiment, the structure 54 thus formed contains the magnetostrictive layers 51 and 53 with the support layer 52 interposed therebetween. Accordingly, the yoke 58 holds the structure 54 from above and below at the vibratable end while the permanent magnets 55 and 57 sandwich the structure 54 from above and below at the fixed end to form a magnetic path.

A coil 59 is wound around the structure 54, that is, around the magnetostrictive layers 51 and 53. As in the second embodiment, the structure according to the third embodiment contains one coil shared by two magnetostrictive members to generate electric power.

The support layer 52 functions also as a vibration linking member that links vibrations of the magnetostrictive layers 51 and 53. It can also be regarded that the yoke member 58, which connects the vibratable ends of the magnetostrictive layers 51 and 53, is acting as a vibration linking member.

A member 60 of a nonmagnetic substance (such as copper, plastic, or ceramic) is disposed in the gap portion surrounded by the permanent magnets 55 and 57 and the yoke member 56. The yoke member 56 located at the fixed end is attached to a mounting member 61 designed to mount the power generation device on an external vibration source. Here, from the standpoint that the magnetostrictive layers 51 and 53 (i.e., the structure 54) is held in a cantilever structure, the permanent magnet 55, yoke member 56, and permanent magnet 57 (and the member 60) can be regarded as working as part of the support member 62. The portion attached to the mounting member 61 to perform power generating motion is hereinafter referred to as power generation structure 63.

Next, a power generation device according to the modification of the third embodiment is described below with reference to FIG. 6B. A structure 63A, which is the same as the power generation structure 63 according to the third embodiment except for the absence of the coil 59, is placed in a case 71. The structure 63A is attached to the case 71 via the yoke member 56 disposed at the fixed end, and the case 71 is attached to an external vibration source so that a structure 54, which includes the magnetostrictive layers 51 and 53, vibrate in the case 71.

The case 71 is made of, for example, plastic material. A coil 72 is wound around the case 71, which has the same effect as winding the coil 72 around the magnetostrictive layers 51 and 53, to cause electric power to be generated. Thus, the coil 72 may be wound around the case 71 as in this modification instead of winding the coil 59 directly around the magnetostrictive layers 51 and 53 as in the third embodiment illustrated in FIG. 6A.

The case 71 is preferably made of a nonmagnetic material with high insulation performance (such as plastic and ceramic). The case 71 may have a closed structure so that the internal pressure in the case 71 can be reduced to prevent the vibration of the structure 54 from being depressed by air.

Next, a vibration power generation device according to a comparative example is described below. The vibration power generation device according to the comparative example is quoted from Non-Patent Document 2.

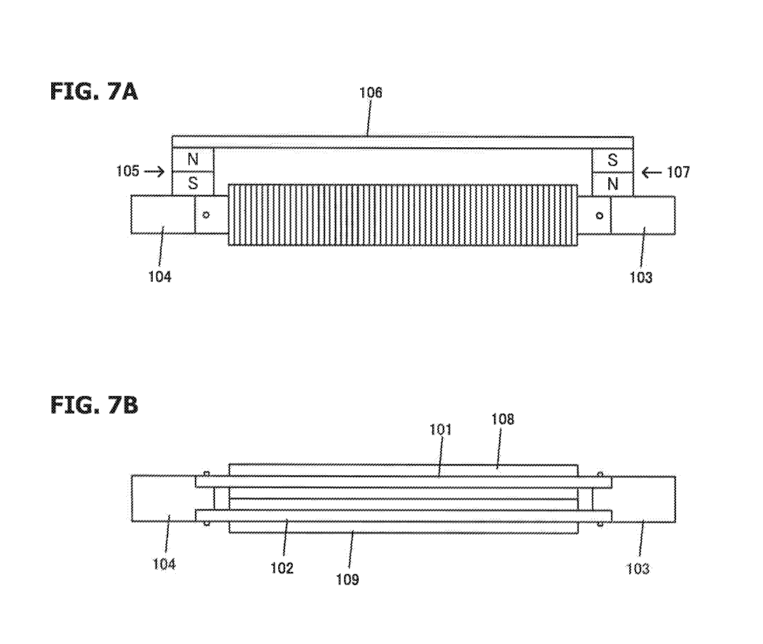

FIG. 7A and FIG. 7B are a schematic top view and a schematic front view, respectively, of the vibration power generation device according to the comparative example. The vibration power generation device according to the comparative example includes magnetostrictive members 101 and 102 disposed opposite to each other. Both the magnetostrictive members 101 and 102 may be made of, for example, a positive magnetostrictive material. Each of the magnetostrictive members 101 and 102 is attached to the yoke member 103 at one end and attached to the yoke member 104 at the other end. A permanent magnet 105 is attached to the yoke member 104 while a permanent magnet 107 is attached to the yoke member 103, and the permanent magnet 105 and the permanent magnet 107 are connected via a yoke member 106.

The magnetic path formed in the example illustrated in FIG. 7A and FIG. 7B runs from the S pole to the N pole of the permanent magnet 107, passes through the yoke member 103, runs from one end to the other end of the magnetostrictive members 101 and 102, passes through the yoke member 104, runs from the S pole to the N pole of the permanent magnet 105 and from the end near the permanent magnet 105 to the end near the permanent magnet 107 of the yoke member 106, and returns to the permanent magnet 107. In the vibration power generation device according to the comparative example, the magnetic fields applied to the magnetostrictive members 101 and 102 are in the same direction, and the yoke member 106 acts as magnetic return path member.

Coils 108 and 109 are wound around the magnetostrictive members 101 and 102, respectively. Either of the yoke members, for example the yoke member 103, is attached to an external vibration source, and the magnetostrictive members 101 and 102 vibrate with the end near the yoke member 103 and that near the yoke member 104 acting as fixed end and vibratable end, respectively.

When the magnetostrictive members 101 and 102 are strained downward as they vibrate, a tensile strain is caused in the upper magnetostrictive member 101 to increase the magnetic flux while a compressive strain is caused in the lower magnetostrictive member 107 to decrease the magnetic flux. When the magnetostrictive members 101 and 102 are strained upward, a compressive strain is caused in the upper magnetostrictive member 101 to decrease the magnetic flux while a tensile strain is caused in the lower magnetostrictive member 107 to increase the magnetic flux. The changes in magnetic flux due to vibration induce electric currents in the coils 108 and 109, thereby generating power.

In the vibration power generation device according to the comparative example, the magnetic fields applied to the magnetostrictive members 101 and 102 are in the same direction, and the yoke member 106 is provided to act as magnetic return path member. Accordingly, the yoke member 106 vibrates together with the magnetostrictive members 101 and 102 as they vibrate. This indicates that the rigidity of the vibration portion of the vibration power generation device is increased as an effect of the yoke member 106. Thus, it is difficult to enhance the power generation efficiency under low acceleration vibration.

The vibration power generation devices according to the embodiments contain two magnetostrictive members disposed opposite to each other to form mutual magnetic return path members, eliminating the need for additional yoke members to be provided to form magnetic return path members. Accordingly, it is easier to decrease the rigidity of the vibration portion compared to the power generation device according to the comparative example, making it easier to enhance the power generation efficiency under low acceleration vibration. It can also be regarded that power generation efficiency is enhanced by allowing magnetostrictive members acting as magnetic return path members to take part in power generation.

In the vibration power generation devices according to the embodiments, furthermore, magnetic fields are induced in the same direction in the two magnetostrictive members when the two magnetostrictive members disposed opposite to each other are of the same magnetostriction type (positive or negative). This proves the effectiveness of adopting a structure in which a shared coil is wound around two magnetostrictive members.

In such a case, furthermore, it is also possible to adopt a structure in which a coil is wound around a container that contains two magnetostrictive members, instead of a structure in which a coil is wound directly around two magnetostrictive members. If a coil is wound directly around two magnetostrictive members, the coil will vibrate to some extent together with the magnetostrictive members. From the viewpoint of decreasing the rigidity of the vibration portion, it is preferable to adopt a structure that contains a container with a coil wound therearound.

The connection member used to magnetically or mechanically connect the two magnetostrictive members disposed opposite to each other (such as the permanent magnet 4 used in the first embodiment given in FIG. 1 and the yoke member 58 used in the third embodiment given in FIG. 6) may function also as a weight to achieve efficient vibration of the magnetostrictive members. Such a connection member may be adjusted so as to have appropriately selected features including shape and weight.

In addition, other features including the size and shape of the magnetostrictive members, size and shape of the magnets and yoke members that form a magnetic path, the support structure for supporting the magnetostrictive members on the support member, and the attachment structure for attaching the power generation device to a vibration source may also be modified appropriately. Furthermore, the materials of the magnetostrictive members are not limited to Galfenol.

As described above, a magnetic path, that an ends of two magnetostrictive members arranged in parallel and in vibratable are magnetically connected and the other ends thereof are magnetically connected, that magnetic fields of opposite directions are applied to the magnetostrictive members, and that the magnetostrictive members act mutually as magnetic return parts of the magnetic path, can be formed. For example, this makes it easier to decrease the rigidity of the vibratable portion of a vibration power generation device and thereby improve its power generation efficiency.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

1. An electric power generation device comprising:
a support member;
a first magnetostrictive member attached to the support member, one end of the first magnetostrictive member acting as a fixed end to the support member, and the other end of the first magnetostrictive member acting as a vibratable end;
a second magnetostrictive member attached to the support member and disposed in parallel with the first magnetostrictive member, one end of the second magnetostrictive member acting as a fixed end to the support member, and the other end of the second magnetostrictive member acting as a vibratable end;
a vibration linking member connecting the first and second magnetostrictive members to allow the first and second magnetostrictive members to vibrate coordinately;
a coil wound around at least either the first magnetostrictive member or the second magnetostrictive member; and
a magnetic path forming member containing magnet, connecting magnetically between one ends of the first and second magnetostrictive members and between the other ends thereof, applying magnetic fields of opposite directions mutually to the first and second magnetostrictive members, respectively, and forming magnetic path, the first and second magnetostrictive members acting mutually as magnetic return parts of the magnetic path.

2. The electric power generation device according to claim 1, further comprising an additional coil, wherein:
the coil is wound around the first magnetostrictive member, and
the additional coil is wound around the second magnetostrictive member.

3. The electric power generation device according to claim 1, wherein the magnetic path forming member additionally works as the vibration linking member.

4. The electric power generation device according to claim 1, wherein the magnetic path forming member contains a yoke member in addition to the magnet.

5. The electric power generation device according to claim 1, wherein the first and second magnetostrictive members constitute a facing portion, that the first and second magnetostrictive members face with each other, of a third magnetostrictive member, and another portion, other than the facing portion, of the third magnetostrictive member constitutes part of the magnetic path forming member.

6. The electric power generation device according to claim 1, wherein:
characteristics of the first and second magnetostrictive members with respect to positive or negative are same, and
the coil is wound around the first and second magnetostrictive members in common.

7. The electric power generation device according to claim 6, wherein the vibration linking member has a plate-like shape, and the first and second magnetostrictive members are disposed on the top face and the bottom face, respectively, of the vibration linking member having the plate-like shape.

8. The electric power generation device according to claim 6, wherein:
the support member has a container portion containing the first and second magnetostrictive members, and
the coil is wound around the container portion of the support member.

9. The electric power generation device according to claim 8, wherein the container portion of the support member has a closed structure with a reduced internal pressure.

10. The electric power generation device according to claim 1, wherein the portion of the magnetic path forming member that magnetically connects the other ends of the first and second magnetostrictive members additionally works as a weight.
